(19) United States
(12) Patent Application Publication
(10) Pub. No.: US 2005/0151574 A1
(43) Pub. Date: Jul. 14, 2005

(54) High voltage output level shifter

(75) Inventor: Kun Tsung Lin, Taichung City (TW)

Correspondence Address: BACON & THOMAS, PLLC, 625 SLATERS LANE, FOURTH FLOOR, ALEXANDRIA, VA, 22314, US

(73) Assignee: Sunplus Technology CO., Ltd., Hsinchu (TW)

(21) Appl. No.: 10/978,363

(22) Filed: Nov. 2, 2004

(30) Foreign Application Priority Data
Jan. 14, 2004 (TW) 093100879

(51) Int. Cl. H02M 1/12

(52) U.S. Cl. 327/333

(57) ABSTRACT

A high voltage output level shifter, which has an input stage circuit, a current mirror and a current path switch. The input stage circuit has a first switch and a second switch. The current mirror has a third switch and a fourth switch. The first switch, the current path switch and the third switch form a current path such that the current path has a direct current when the third switch is turned on, and the fourth switch produces a current for the current mirror to turn off the current path switch, so that the direct current cannot be produced.

### BACKGROUND OF THE INVENTION

1. Field of the Invention

The present invention relates to a level shifter and, more particularly, to a high voltage output level shifter for high-voltage conversion.

2. Description of Related Art

High voltage level shifters are typically applied for low voltage to high voltage control signal conversion. For example, in a large scale liquid crystal display (LCD) system, it requires 20 to 40V to turn on thin-film transistors (TFTs) but an input signal applied to the LCD Driver IC is 3V, or some logic circuits provide such as 1.5V operating voltage for interior thereof, but the operating voltage for its external connected circuit requires 5V. In this case, a high voltage output level shifter is applied for the voltage conversion.

FIG. 1 is a circuit of a conventional high voltage output level shifter. As shown, the shifter includes two PMOSs 11, 12, two NMOSs 13, 14 and an inverter 15. The sources of the PMOSs 11, 12 are connected to a node for providing with an external high voltage HVDD. The sources of the NMOSs 13, 14 are grounded (GND). The drains of the PMOS 11 and NMOS 13 are connected to a node ND1 while the drains of the PMOS 12 and NMOS 14 are connected to a node ND2. Also, the node ND 1 is connected to gates of PMOSs 11 and 12. In addition, a voltage input terminal 161 is connected to the gate of the NMOS 13 and also to the gate of the NMOS 14 through the inverter 15, and the PMOSs 11, 12 form a current mirror.

When the voltage input terminal 161 inputs a low voltage (0V), the NMOS 13 is turned off and the NMOS 14 is turned on, and accordingly current path from the PMOS 11 to the NMOS 13 has no current. Thus, the PMOS 12 does not produce the mirror current so as to pull potential of the output terminal 162 down to 0V When the voltage input terminal 161 inputs a high voltage (such as 5V), the NMOS 13 is turned on and the NMOS 14 is turned off, and accordingly a current is produced through the current path from the PMOS 11 to the NMOS 13. Thus, a current is mirrored on the PMOS 12. Since the NMOS 14 is turned off, the current on the PMOS 12 leads the output terminal 162 to a HVDD voltage level (such as 15V).

However, high voltage devices in such a way can cause serious consumption of direct power, i.e., direct power on active load path in the current mirror, even though entire circuit in such a configuration requires smaller area.

FIG. 2 is a circuit of another high voltage output level shifter. As shown, two current mirrors improve the problem of direct current leakage in the high voltage output level shifter of FIG. 1. However, a high voltage output level shifter using such a circuit requires at least eight high-pressure processing devices, which is not practical.

Therefore, it is desirable to provide an improved level shifter to mitigate and/or obviate the aforementioned problems.

### SUMMARY OF THE INVENTION

An object of the invention is to provide a high voltage output level shifter, which can be implemented by fewer high voltage processing devices and thus required area becomes smaller.

Another object of the invention is to provide a high voltage output level shifter, which has not direct current consumption in static state.

In accordance with one aspect of the present invention, there is provided a high voltage output level shifter, which includes an input stage circuit and a current mirror. The input stage circuit has a first switch and a second switch, which are alternately turned on based on a low voltage signal received by the input stage circuit. The current mirror has a third switch and a fourth switch and is connected to a high voltage source, wherein the third switch is connected with the first switch through a current path switch such that the third switch, the current path switch and the first switch form a current path, and the fourth switch is connected to the second switch such that the third switch and the fourth switch are driven by turning the first or second switch on, thereby outputting a high voltage signal and producing a mirror current to control the current path switch for cutting off current of the current path.

In accordance with another aspect of the present invention, there is provided a high voltage output level shifter, which includes an input stage circuit, a current mirror and a current switch. The input stage circuit has a first switch and a second switch and is connected to a first voltage node such that voltage signal of the first voltage node controls the first or second switch to be alternately turned on. The current mirror is connected to a second voltage node and has a third switch, a fourth switch and a current switch between the input stage circuit and the current mirror such that the third switch and the fourth switch are controlled to be on or off by turning the first or second switch on, thereby outputting a high voltage signal. When the third and the fourth switches are turned on, a mirror current and a direct current are produced such that the mirror current controls the current path switch for cutting off the direct current.

Other objects, advantages, and novel features of the invention will become more apparent from the following detailed description when taken in conjunction with the accompanying drawings.

### BRIEF DESCRIPTION OF THE DRAWINGS

FIG. 1 is a circuit of a conventional high voltage output level shifter;

FIG. 2 is a circuit of another conventional high voltage output level shifter;

FIG. 3 is a circuit of a high voltage output level shifter in accordance with an embodiment of the invention;

FIG. 4 is a circuit of a high voltage output level shifter in accordance with another embodiment of the invention;

FIG. 5 is a circuit of a high voltage output level shifter in accordance with a further embodiment of the invention;

FIG. 6 is a circuit of a high voltage output level shifter in accordance with another further embodiment of the invention; and

FIG. 7 is a comparison graph of direct current consumption.

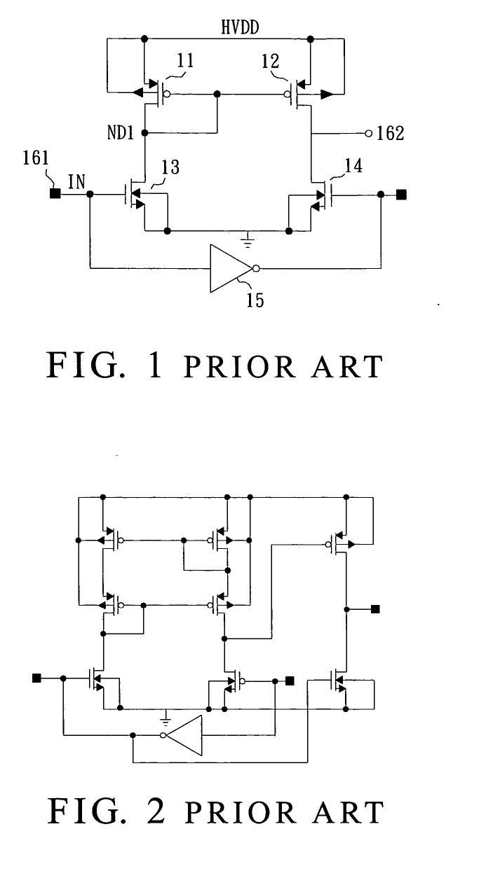

### DETAILED DESCRIPTION OF THE PREFERRED EMBODIMENT

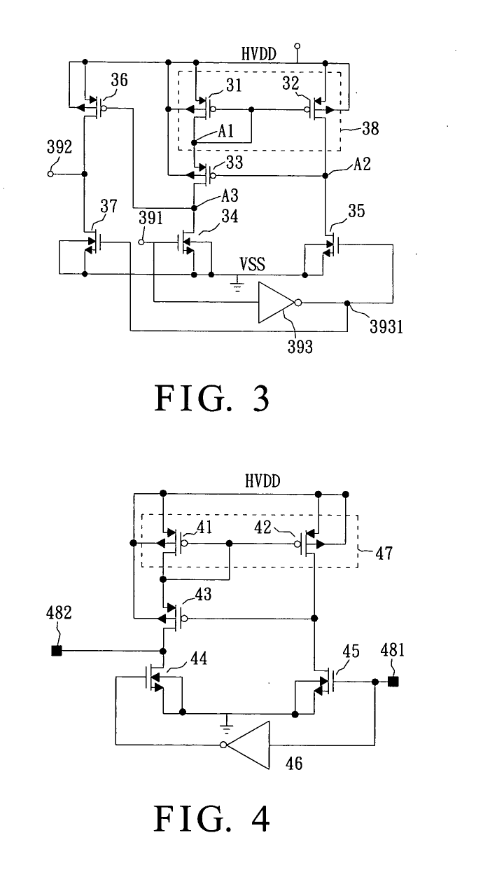

FIG. 3 is a circuit of a high voltage output level shifter in accordance with an embodiment of the invention. As shown, the level shifter essentially consists of P-type metal oxide semiconductors (MOSs) 31-33 and 36, N-type MOSs 34, 35 and 37, and an inverter 393, wherein P-type MOSs devices 31 and 32 forms a current mirror 38.

As shown, the sources of the PMOSs 31, 32 and 36 are connected with a high voltage source HVDD (such as 40V) through a high voltage node while the sources of the NMOSs 34, 35 and 37 are connected with a ground source VSS through a low voltage node.

The drains of the NMOS 37 and PMOS 36 are connected together to an output terminal 392. The source of the PMOS 33, the drain of the PMOS 31 and the gate of the PMOS 32 are connected to a node A1. The drain of the PMOS 33, the drain of the NMOS 34 and the gate of the PMOS 36 are connected to a node A3. The drain of the NMOS 35, the drain of the PMOS 32 and the gate of the PMOS 33 are connected to a node A2. The gate of the NMOS 34 is connected to a control input terminal 391 to receive a low control signal (such as 2V). The control input terminal 391 further connects to an inverter 393, which inverts the received low control signal and outputs the inverted signal to the gates of the NMOSs 35 and 37 through the output terminal 3931 thereof.

In such a circuit configuration, when the low control signal is at low voltage (such as 0V), the NMOS 34 is in off state and the NMOSs 35 and 37 are in turned-on state. Accordingly, the PMOSs 31 and 33 are in off state because they are located on a current path, as the same as the NMOS 34. Since the PMOS 31 is in off state, a voltage on the node A1 is about 38V (i.e., HVDD-VT). Because the PMOS 31 and PMOS 32 form the current mirror 38, when the PMOS 31 is in off state, it causes the PMOS 32 also to be in off state, and thus the current mirror 38 consisting of the PMOSs 31 and 32 has no current flow.

In addition, a voltage on the node A2 is close to 0V due to the NMOS 35 is in on state, thus the p-channel of the PMOS 33 is turned on and has no current flow. At this point, for a condition that no current passes through the PMOS 33, a voltage on the node A3 must be about 38V the same as that on the node A1. As such, the PMOS 36 is in off state and the output terminal 392 outputs a low voltage (such as 0V).

When the low control signal is at high voltage (such as 2V), the NMOS 34 is in on state and the NMOSs 35 and 37 are in off state. Because of the NMOS 34 is in on state, a direct current path is generated, i.e., a direct current flows through the PMOSs 31, 33 and NMOS 34. As such, the PMOS 32 produces a mirror current to charge drain of the NMOS 35, such that voltage on the node A2 increases from 0V and turns the PMOS 33 into off state. When the PMOS 33 is in off state, voltage on the node A3 is of a low level due to that the NMOS 34 is in on state, such that the PMOS 36 is turned on and the output terminal 392 outputs a high voltage (such as 40V).

FIG. 4 is a circuit of a high voltage output level shifter in accordance with another embodiment of the invention. As shown, the level shifter essentially consists of PMOSs 41-43, NMOSs 44 and 45 and an inverter 46, wherein the PMOSs 41 and 42 forms a current mirror 47. As shown in FIG. 4, an output terminal 482 is implemented between the drains of the PMOS 43 and NMOS 44. However, in FIG. 3, the output terminal 392 is implemented at a connection of the PMOS 36 and the NMOS 37 which form an output stage circuit that is not seen in FIG. 4.

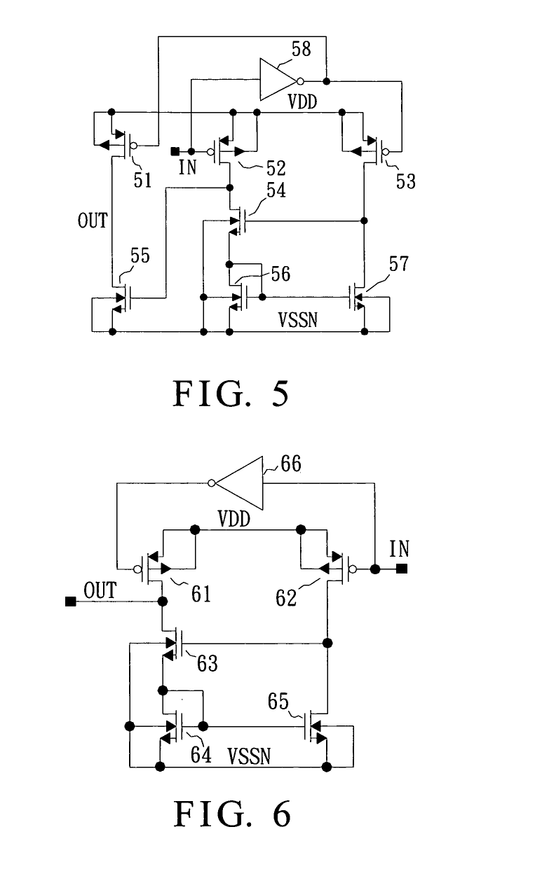

FIG. 5 is a circuit of a high negative voltage output level shifter in accordance with a further embodiment of the invention. As shown, the level shifter essentially consists of PMOSs 51-53, NMOSs 54-57 and an inverter 58. The circuit is operated similar to that of FIG. 3 except for an output signal. The output signal is a positive voltage (such as 40V) in FIG. 3 but a negative voltage (such as −40V) in FIG. 5. Therefore, as shown in FIG. 5, the PMOSs 52 and 53 form a switch of receiving the input low control signal, and the NMOS 54 is a switch of controlling a current mirror consisting of the NMOSs 56 and 57.

FIG. 6 is a circuit of a high negative voltage output level shifter in accordance with another further embodiment of the invention. As shown, the level shifter essentially consists of PMOSs 61-62, NMOSs 63-65 and an inverter 66. The circuit in FIG. 6 is similar to that of FIG. 4 except for a high negative voltage to output. The high voltage to output in FIG. 6 is inverted to that in FIG. 4. Accordingly, all devices and output operating voltages are inverted to each other. Namely, the NMOSs 44-45 and PMOSs 41-43 in FIG. 4 are changed into the PMOSs 61-62 and NMOSs 63-65 in FIG. 6, the inverter 46 in FIG. 4 is connected across the gates of the NMOSs 44-45 but the inverter 66 in FIG. 6 is connected across the gates of the PMOSs 61-62, and the sources of the PMOSs 41 and 42 in FIG. 4 are connected with HVDD but the sources of the NMOSs 64 and 65 in FIG. 6 are connected with a high negative voltage source VSSN.

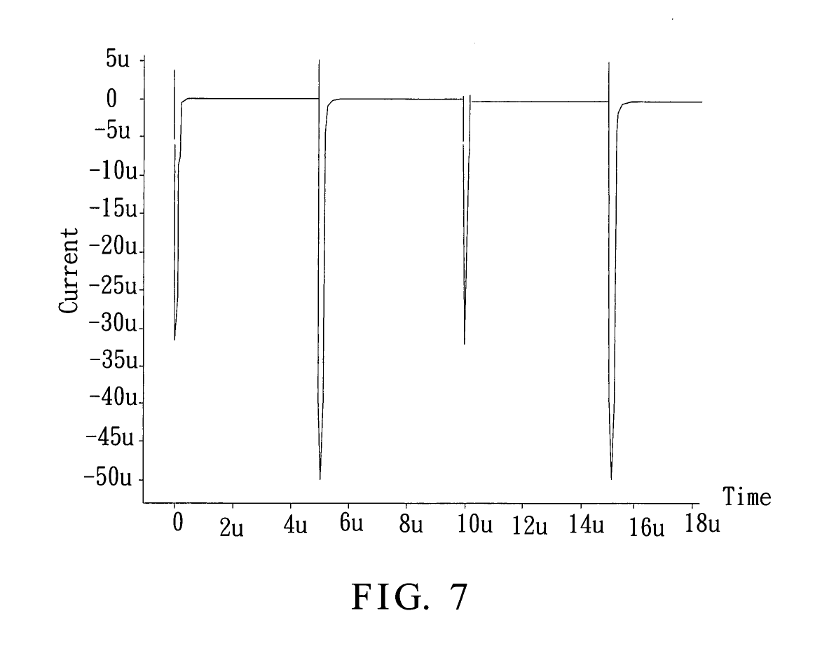

FIG. 7 is a comparison graph of direct current consumption. As shown, direct current consumption presents in the inventive high voltage output level shifter only at transition moment. In other words, no direct current consumption presents in steady state. Accordingly, the problem of serious direct current consumption in prior art is improved to further achieve the purpose of using fewer high voltage processing devices (such as seven devices including output stage) to implement the circuit, thus required area for entire circuit is reduced.

In view of the forgoing, it is known that the invention essentially uses multiple MOSs to form an input stage circuit, a current mirror and a current path switch. The input stage circuit receives a low control signal. The current mirror is connected to a high voltage such that the input stage circuit can control the current path switch on or off in accordance with the low control signal to further determine whether or not the current mirror produces mirror current, and the current path can eliminate direct current consumption between the current mirror and the input stage circuit so that the high output level shifter has not direct current consumption at static, thereby reducing required circuit area.

Although the present invention has been explained in relation to its preferred embodiment, it is to be understood that many other possible modifications and variations can be made without departing from the spirit and scope of the invention as hereinafter claimed.

1. A high voltage output level shifter, which converts a voltage level of an input signal into different voltage level for output, comprising:
an input stage circuit consisting of a first switch and a second switch, which receives a low voltage signal such that the first and the second switches are alternately turned on in accordance with the low voltage signal;
a current mirror consisting of a third switch and a fourth switch, which is connected to a high voltage source,
wherein the third switch is connected with the first switch through a current path switch such that the third switch, the current path switch and the first switch form a current path, and the fourth switch is connected to the second switch such that the third switch and the fourth switch are driven by turning the first or second switch on, thereby outputting a high voltage signal and producing a mirror current to control the current path switch for cutting off current of the current path.

2. The high voltage output level shifter as claimed in claim 1, further comprising an output stage circuit consisting of a fifth switch and a sixth switch connected to the current mirror and the input stage circuit respectively.

3. The high voltage output level shifter as claimed in claim 1, wherein the first switch and the second switch are N-type metal oxide semiconductors (MOSs).

4. The high voltage output level shifter as claimed in claim 1, wherein the third switch, the fourth switch and the current path switch are P-type metal oxide semiconductors (MOSs).

5. A high voltage output level shifter, which converts a voltage level of an input signal into different voltage levels for output, comprising:
an input stage circuit, which has a first switch and a second switch and is connected to a first voltage node such that a voltage signal received by the first voltage node controls the first or second switch to be alternately turned on;
a current mirror, which is connected to a second voltage node, and has a third switch, a fourth switch and a current switch between the input stage circuit and the current mirror, such that the third switch and the fourth switch are controlled to be on or off by turning the first or second switch on, thereby outputting a high voltage signal,
wherein when the third and the fourth switches are turned on, a mirror current and a direct current are produced such that the mirror current controls the current path switch for cutting off the direct current.

6. The high voltage output level shifter as claimed in claim 5, wherein the direct current flows from the current mirror to the input stage circuit.

7. The high voltage output level shifter as claimed in claim 5, wherein the first switch, the third switch and the current switch form a current path to produce the direct current.

8. The high voltage output level shifter as claimed in claim 7, wherein the current path does not produce the direct current when the current switch is turned off as the current mirror produce the mirror current.

9. The high voltage output level shifter as claimed in claim 5, wherein the first voltage node inputs a low-level voltage signal.

10. The high voltage output level shifter as claimed in claim 5, wherein the second voltage node inputs a high-level voltage signal.

11. The high voltage output level shifter as claimed in claim 5, further comprising an output stage circuit consisting of a fifth switch and a sixth switch connected to the current mirror and the input stage circuit respectively.

12. The high voltage output level shifter as claimed in claim 5, wherein the first switch and the second switch are N-type metal oxide semiconductors (MOSs).

13. The high voltage output level shifter as claimed in claim 5, wherein the third switch, the fourth switch and the current path switch are P-type metal oxide semiconductors (MOSs).

14. The high voltage output level shifter as claimed in claim 5, wherein the first switch and the second switch are P-type metal oxide semiconductors (MOSs).

15. The high voltage output level shifter as claimed in claim 5, wherein the third switch, the fourth switch and the current path switch are N-type metal oxide semiconductors (MOSs).
